(19) United States
(12) Patent Application Publication
(10) Pub. No.: US 2015/0291453 A1
(43) Pub. Date: Oct. 15, 2015

(54) Functional Water Manufacturing Apparatus With Self-Generated Power

(71) Applicant: PAINO INC., Seoul (KR)

(72) Inventors: Seong Tae Kim, Seoul (KR); Keun Kyu Lee, Seoul (KR); Ki Seok Na, Seoul (KR); Young Se Na, Seoul (KR); Joon Seok Kim, Seoul (KR)

(21) Appl. No.: 14/432,084

(22) PCT Filed: Sep. 26, 2013
(86) PCT No.: PCT/KR2013/008633

§ 371 Date: Mar. 27, 2015

(30) Foreign Application Priority Data
Sep. 28, 2012 (KR) 10-2012-0108493

(51) Int. Cl. C02F 1/461; C25B 9/08; C25B 1/00

(52) U.S. Cl. CPC C02F 1/46104; C25B 1/00; C25B 9/08; C02F 2201/46115; C02F 2201/4616; C02F 2201/46125

(57) ABSTRACT

A functional water manufacturing apparatus with self-generated electric power is disclosed, the apparatus includes: a water storing chamber configured to store one of a tap water, a purified water, a distilled water, and a water containing an adduct; an electrode unit configured to form a bottom surface by being coupled to a lower part of the water storing chamber, and to expose one of a positive electrode and a negative electrode; and a power supply unit configured to supply an electric power to the electrode unit by being arranged at a lower part of the electrode unit, and to generate an electric power by converting a kinetic energy added by a user to an electric energy, wherein the electrode unit converts the water stored in the water storing chamber to a functional water, by being supplied with the electric power from the power supply unit.

### BACKGROUND/FIELD OF THE DISCLOSURE

The present disclosure relates to a functional water manufacturing apparatus adoptable to beauty and health supplies.

### DISCUSSION OF THE RELATED ART

Recently, according to increasing public attentions to health and beauty, various portable devices are being introduced to supply skins dried by indoor heater operations or outdoor activities with moisture, or to sterilize hands after using a restroom or before/after having a meal. The former, commonly referred to as a “mist”, is widely used by women. The mist includes various toilet water components as well as water for rehydration, to help skin moisturizing.

Further, recently, portable toilet water sterilizers, which can function both as the mist and the sterilizing water, are being developed. One of such examples is a Korean patent No. 10-1080227 (PORTABLE BEAUTY WASH STERILIZER).

However, the abovementioned portable beauty wash sterilizer has an inconvenience in that a separate battery power supply (two AAA-typed batteries) should be replaced by a certain period of time. In addition, the electrolysis is not conducted when using water other than a tap water. Thus, distilled water or water purified by an R/O (reverse osmosis) process cannot be used. Otherwise, chorine and stench may be generated to give the user an unpleasant feeling when electrolyzing the water. Especially, side effects due to beauty treatment and sterilization using chlorine may occur, because the generated water is used with any separation by use such as a cosmetic use or a sterilizing use.

### SUMMARY OF THE DISCLOSURE

One object of the present disclosure is to provide a functional water manufacturing apparatus with a self-generated electric power unit to operate an electrolyzing filter, which is able to use distilled water other than tap water.

In a general aspect of the present disclosure, there is provided a functional water manufacturing apparatus with self-generated electric power, the apparatus comprising: a water storing chamber configured to store one of a tap water, a purified water, a distilled water, and a water containing an adduct; an electrode unit configured to form a bottom surface by being coupled to a lower part of the water storing chamber, and to expose one of a positive electrode and a negative electrode; and a power supply unit configured to supply an electric power to the electrode unit by being arranged at a lower part of the electrode unit, and to generate an electric power by converting a kinetic energy added by a user to an electric energy, wherein the electrode unit converts the water stored in the water storing chamber to a functional water, by being supplied with the electric power from the power supply unit.

In some exemplary embodiments of the present disclosure, the electrode unit may include an electrode module having a diameter corresponding to a diameter of the water storing chamber, and the electrode module may include: a first frame and a second frame; a first electrode and a second electrode interposed between the first frame and the second frame, each of the first and second electrodes connected to a power source of different polarity; and a solid polymer electrolyte membrane interposed between the first electrode and the second electrode.

In some exemplary embodiments of the present disclosure, the power supply unit may include: a control module unit conductively connected to the first and second electrodes, by being arranged at a lower part of the electrode unit; and a power generation unit to convert a kinetic energy of a user to an electric energy, by being conductively connected to the control module unit, wherein the power generation unit may include: a core block installed by being fixed inside the power supply unit; a coil wound on the core block; a guide rail arranged in a longitudinal direction of the power supply unit, so as to be concentric with the core block; and a magnet to move along the guide rail.

In some exemplary embodiments of the present disclosure, the magnet may have, in a center thereof, a through-hole in a shape corresponding to a diameter of the guide rail, and is formed smaller than a diameter of an internal space of the core block.

In some exemplary embodiments of the present disclosure, the power generation unit may include: a pair of elastic members to collide with the magnet during reciprocative movement of the magnet, by being installed at both ends of the guide rail.

In some exemplary embodiments of the present disclosure, the elastic member may contact by a point contact with the magnet when initially contacting with the magnet, by being provided in a shape of a sphere made of either one of a rubber, a silicon, or an urethane material.

In some exemplary embodiments of the present disclosure, the elastic member may be formed as either one of a coil spring or a leaf spring, and a shape of the spring is transformable by an impact occurring when colliding with the magnet.

In some exemplary embodiment of the present disclosure, a sealing member may be interposed between the first and second electrodes and the control module unit, to prevent the water stored in the water storing chamber from being injected into the control module unit.

In some exemplary embodiment of the present disclosure, the power supply unit may include, on a bottom surface thereof, an attachable/detachable cover member.

In some exemplary embodiment of the present disclosure, the water storing chamber may include, at an upper part thereof, one of a micro-droplet spray unit and a lid member, being attachably and detachably coupled with the water storing chamber.

In some exemplary embodiment of the present disclosure, the micro-droplet spray unit may include: a sealing cover member screw-coupled to an upper opening of the water storing chamber; a pumping unit coupled by being fixed to a center of the sealing cover member; a pipe member, by being connected to a center of the pumping unit, to supply the functional water in the water storing chamber to the pumping unit; and a cap member to protect the pumping unit.

In some exemplary embodiment of the present disclosure, the power supply unit may generate an electric power during reciprocative movement in a longitudinal direction of the functional water manufacturing apparatus.

In some exemplary embodiment of the present disclosure, the control module unit may further include a switching unit to ON/OFF-control an electric power applied to the first and second electrodes.

In some exemplary embodiment of the present disclosure, the switching unit may further include a function to convert a polarity of the electric power applied to the first and second electrodes.

According to an exemplary embodiment of the present disclosure, a user can choose and use any desirable raw water such as purified water and distilled water other than tap water, because the water may be electrolyzed irrespective of quality of the raw water.

According to an exemplary embodiment of the present disclosure, a user can produce electric power required for operating the apparatus by shaking the apparatus 5 to 10 times, without any inconvenient maintenance such as battery replacement or charging rechargeable batteries. Thus, the apparatus according to an exemplary embodiment of the present disclosure may be used semi-permanently in comparison with conventional products, and may be safer because a low-capacity electric power is used.

The apparatus according to an exemplary embodiment of the present disclosure is lighter and more portable, and may be produced at a lower cost, because the apparatus according to an exemplary embodiment of the present disclosure can be manufactured in a small size.

According to an exemplary embodiment of the present disclosure, the apparatus may, by changing positions of electrodes, manufacture functional water including hydrogen for a cosmetic use, or may manufacture SPI (Super Plasma Ion) including ozone for a sterilizing use, according to the user's need. Therefore, the apparatus according to an exemplary embodiment of the present disclosure can enhance the user convenience.

### BRIEF DESCRIPTION OF THE DRAWINGS

FIG. 1 is a perspective view illustrating a functional water manufacturing apparatus with self-generated electric power according to an exemplary embodiment of the present disclosure.

FIG. 2 is an exploded perspective view of FIG. 1.

FIG. 3 is a schematic cross-sectional view of FIG. 1.

FIG. 4 is a view schematically illustrating a state of forming hydrogen and ozone by operation of an electrode module according to an exemplary embodiment of the present disclosure.

FIG. 5 is a schematic block diagram illustrating a power supply unit according to an exemplary embodiment of the present disclosure.

FIG. 6 is a perspective view illustrating a functional water manufacturing apparatus with self-generated electric power according to another exemplary embodiment of the present disclosure.

### DETAILED DESCRIPTION

Hereinafter, referring to accompanying drawings, exemplary embodiments of the present disclosure will be described in detail.

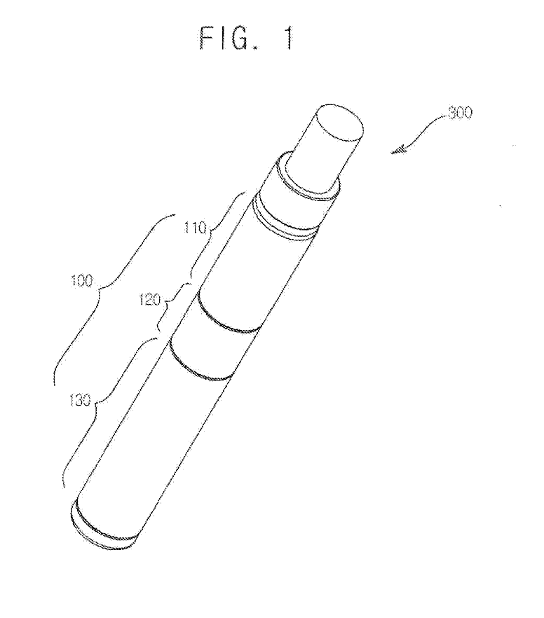

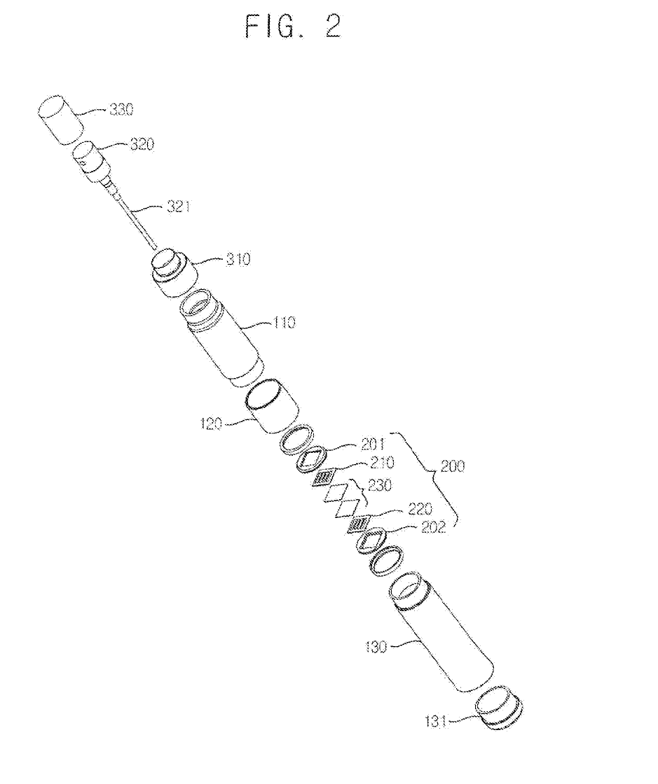

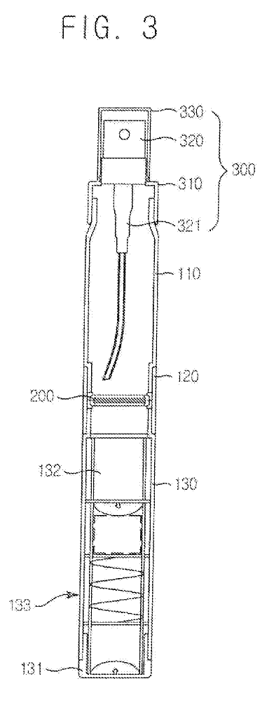

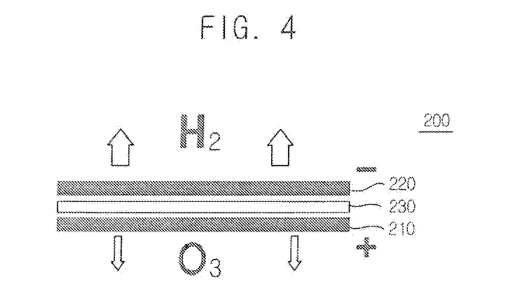

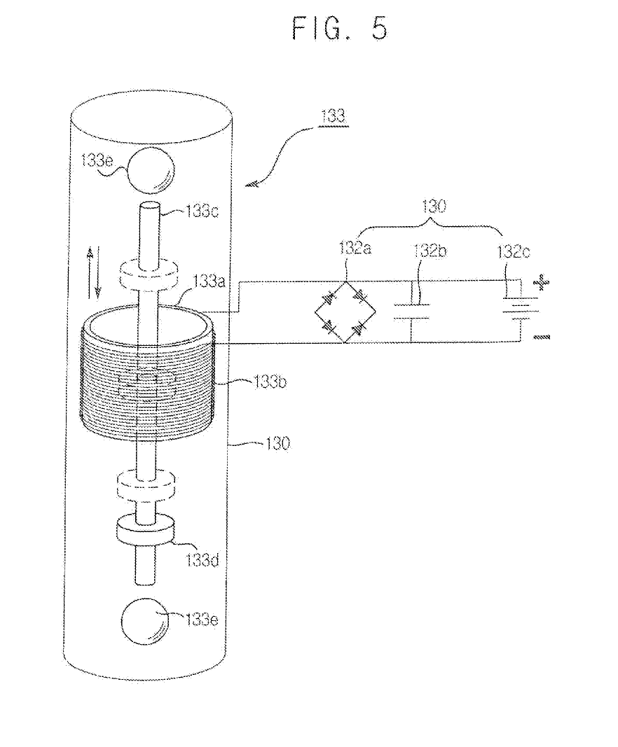

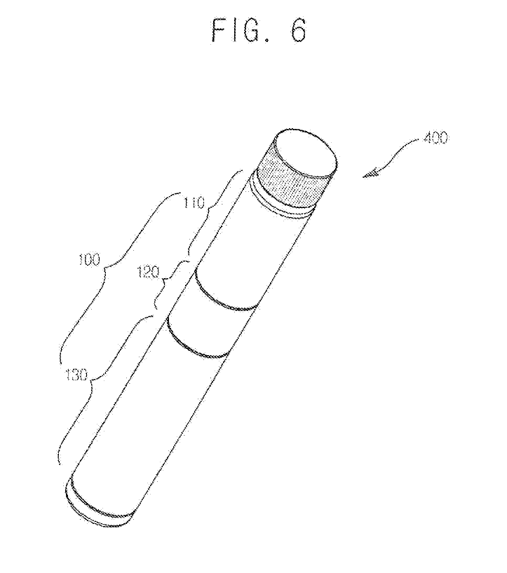

FIG. 1 is a perspective view illustrating a functional water manufacturing apparatus with self-generated electric power according to an exemplary embodiment of the present disclosure; FIG. 2 is an exploded perspective view of FIG. 1; FIG. 3 is a schematic cross-sectional view of FIG. 1; FIGS. 4 and 5 are a plan view and a lateral view, respectively, illustrating an electrode of functional water manufacturing apparatus according to an exemplary embodiment of the present disclosure; and FIG. 6 is a schematic block diagram illustrating a power supply unit according to an exemplary embodiment of the present disclosure.

A functional water manufacturing apparatus with self-generated electric power according to an exemplary embodiment of the present disclosure may include, inside a housing thereof, a water storing chamber (110), an electrode unit (120), and a power supply unit (130). Here, the water storing chamber (110), the electrode unit (120), and the power supply unit (130) may be collectively formed as a single body, or otherwise, each of them may be provided as a separate component and attachably/detachably formed.

The water storing chamber (110) may, as illustrated in FIGS. 1 and 2, be provided in a shape of a cylinder to contain water in an internal space unit thereof. The water may be selectively used from tap water, water purified by an R/O (reverse osmosis) filter unit, distilled water, or post-processed water through a predetermined process. One of characteristics of the present disclosure is that a user can use any desirable kind of water, in contrast with the conventional functional water manufacturing apparatuses using electrolysis which can only use the tap water.

The electrode unit (120) may be arranged at a lower part of the water storing chamber (110), so that an electrode module (200) (to be described afterwards) may form a bottom surface of the water storing chamber (110). Here, the electrode unit (120) may be provided in a shape of a cylinder with top and bottom opened and connected to the water storing chamber (110).

The electrode module (200) may include a first frame (201) and a second frame (202), a first electrode (210) and a second electrode (220) interposed between the first frame (201) and the second frame (202), and a solid polymer electrolyte membrane (230) interposed between the first electrode (210) and the second electrode (220).

Such structure of the electrode module (200) may be provided as an apparatus disclosed in a Korean patent No. 10-564654 (An apparatus for producing ozone by electrolysis). According to the structure of the issued Korean patent, the electrode module (200) may include a first electrode (210) as a positive electrode to generate an electrolysis reaction in water, and may include a second electrode (220) arranged to be opposite to the first electrode (210), as a negative electrode to generate an electrolysis reaction in water.

The solid polymer electrolyte membrane (230) may deliver hydrogen ions generated by an electrolysis reaction between the first electrode (210) and the second electrode (220) provided as a positive electrode and a negative electrode, respectively.

Meanwhile, as illustrated in FIG. 4, an auxiliary electrode (not illustrated in the figure) may be provided between the second electrode (220) provided as a negative electrode and the solid polymer electrolyte membrane (230). The auxiliary electrode may reduce generation of scale on a surface of the negative electrode, by pushing hydrogen ions generated from the first electrode (210) as a positive electrode through the negative electrode, and by generating scale generated whereby an OH-ion generated from the second electrode (220) as a negative electrode reacts with a positive divalent ion on a surface of the auxiliary electrode.

Meanwhile, according to an exemplary embodiment of the present disclosure, water can be electrolyzed without battery, because the water is electrolyzed by using the solid polymer electrolyte membrane (230) and therefore ozone or hydrogen can be generated by using a low capacity of electric power. In general, apparatuses which generate electric power of 3 to 5 W in maximum to perform electrolysis are disclosed. However, according to an exemplary embodiment of the present disclosure, the electrolysis can be performed even in an environment under 1 W of electric power. Therefore, a power supply unit (130) can be formed in a more simple structure compared to these conventional apparatuses.

Therefore, the negative electrode may be formed so as to head toward an internal bottom surface opposite to the water stored in the water storing chamber (110), when including hydrogen ions in the water stored in the water storing chamber (110). Otherwise, the positive electrode may be formed so as to head toward an internal bottom surface opposite to the water stored in the water storing chamber (110), when including ozone in the water stored in the water storing chamber (110).

According to such structure of the present disclosure, a functional water, which has expected effects such as skin aging prevention, active oxygen removal, wrinkle improvement, skin moisturizing, skin trouble improvement, etc., may be generated, when hydrogen (H₂) is included in the water stored in the water storing chamber (110). In addition, sterilizing water having a surface sterilizing effect to kill bacteria such as colon bacillus may be formed, when ozone (O₃) is included in the water stored in the water storing chamber (110). Thus, a functional water, which has expected effects such as sterilization and deodorization and can be used as a portable hand sterilizer, may be generated.

A power supply unit (130) may supply electric power to the electrode module (200) provided at the electrode unit (120), by being arranged at a lower part of the electrode unit (120). The power supply unit (130) may include a cover member (131), a control module unit (132), and a power generation unit (133), as illustrated in FIG. 3.

The cover member (131) may be attachably and detachably installed on a bottom surface of the power supply unit (130). When required, the inside of the power supply unit (130) may be exposed so as to have maintenance.

The control module unit (132) may include a direct current conversion unit (132a), a condenser unit (132b), and a storage battery unit (132c), as illustrated in FIG. 5.

The direct current conversion unit (132a) may convert an alternate current power source generated from the power generation unit (133) (to be described afterwards) to a direct current power source by using a plurality of diodes, and may store a predetermined capacity of power source in the storage battery unit (132c), by condensing the direct current power source in the condenser unit (132b). According to an exemplary embodiment of the present disclosure, the electric power stored in the storage battery unit (132c) may be a direct current of 5V/200 mA.

Meanwhile, although not illustrated in the control module unit (132), a separate switching unit may be provided, so as to ON/OFF control the electric power stored in the storage battery unit (132c). In addition, a type of functional water can be selected by a user's need, by determining whether a polarity of the electric power applied to the first electrode (210) and the second electrodes (220) is to be positive or negative, through polarity conversion by the switching unit.

For example, a positive electrode may be exposed to a bottom surface of the water storing chamber (110), when generating SPI (Super Plasma Ion) functional water including ozone for sterilization. Otherwise, a negative electrode may be exposed to a bottom surface of the water storing chamber (110), when generating functional water including hydrogen for cosmetic use.

Such conversion of the electrode may be performed by the switching unit (not illustrated in the figure). Or otherwise, the conversion may be performed by physically separating the first and second electrodes (210, 220) and converting their direction to adjust positions of polarities.

Meanwhile, the control module unit (132) may be conductively connected to the first and second electrodes (210) (220). A sealing member (not illustrated in the figure) may be installed at a periphery of the first and second electrodes (210) (220), to prevent the water stored in the water storing chamber from being leaked into the control module unit (132).

The user may directly generate an electric power, without using the separate external battery, but by using the power generation unit (133), when required. As illustrate in FIG. 5, the power generation unit (133) may include a core block (133a) installed by being fixed inside the power supply unit (130), a coil (133b) wound on the core block (133a), a guide rail (133c) arranged in a longitudinal direction of the power supply unit (130), so as to be concentric with the core block (133a), a magnet (133d) to move along the guide rail (133c), and an elastic member (133e).

The core block (133a) may be provides as a shape of a cylinder forming a space unit inside thereof, as illustrated in FIG. 5. The coil (133b) may be wound on an outer circumference surface of the core block (133a) by a predetermined number of turns. The winding number of the coil (133b) may be determined in a range between 2,000 and 4,000. The winding number may vary upon the size of the apparatus and the size of electrical power required. Meanwhile, the space unit formed inside of the core block (133a) may be roughly formed in a shape of a cylinder. The diameter of the space unit may be larger than the diameter of the magnet (133d).

The guide rail (133c) may be arranged so as to be concentric with a center of the core block (133a). According to an exemplary embodiment of the present disclosure, one end of the guide rail (133c) may be fixed at a lower part of the control module unit (132) arranged at a lower part of the electrode unit (120), and the other end of the guide rail (133c) may be fixed by the cover member (131).

The magnet (133d) may have, in a center thereof, a through-hole in a shape corresponding to a diameter of the guide rail (133c). The magnet (133d) may move along the guide rail (133c) through the through-hole. The magnet (133d) may be provided as a shape of a sphere having a diameter smaller than that of an internal space of the core block (133a). The diameter of the magnet (133d) may be of a size which is not interfered with the inner circumference surface of the core block (133a). When the user shakes the functional water manufacturing apparatus according to the present disclosure, the magnet (133d) may generate an alternating current power by moving reciprocatively in a direction of the arrow head illustrated in FIG. 5, because the magnet (133d) is arranged so as to move along the guide rail (133c).

The elastic member (133e) may be installed at both ends of the guide rail (133c). The elastic member (133e) may absorb the impact occurring by the collision, by colliding with an internal wall surface before the magnet (133d) collides with the internal wall surface during reciprocative movement of the magnet (133d).

According to an exemplary embodiment of the present disclosure, the elastic member (133e) may contact by a point contact with the magnet (133d) when initially contacting with the magnet, by being provided in a shape of a sphere made of either one of a rubber, a silicon, or an urethane material, but not limited hereto. Therefore, it will be apparent that the elastic member (133e) may have a variety of shapes including a cylindrical shape, when required.

According to another exemplary embodiment of the present disclosure, although it is not illustrated in the figure, the elastic member (133e) may be formed as either one of a coil spring or a leaf spring, the shape of the spring is transformable by an impact occurring when colliding with the magnet (133d).

Meanwhile, as described in the above, the power supply unit (130) according to an exemplary embodiment of the present disclosure may use a self-generating electric condenser of a magnet condenser type using Faraday's law of electromagnetic induction, which may be used semipermanently, in order to solve out the inconvenience of using a separate replaceable battery or a rechargeable battery. However, the power supply unit (130) is not limited hereto. Rather, any kind of various power supply units capable of self-power generation, such as a condenser using solar power and a structure having a rotor to rotate in a direction of an axis by connecting a rotation lever, may be adopted. That is, a coil-wound stator fixed at an internal wall of the power supply unit (130) may be formed, a rotor which is not interfered with the coil-wound stator may be provided in a through-hole formed at a center of the stator, and the electric power may be generated by rotating the rotor by using the rotation lever.

Meanwhile, as illustrated in FIGS. 1 and 2, the functional water manufacturing apparatus according to an exemplary embodiment of the present disclosure may provide functional water manufactured as the mist. For this purpose, a micro-droplet spray unit (300) configured to spray the functional water in minute water particles through pumping operations may be provided at an upper part of the water storing chamber (110).

According to an exemplary embodiment of the present disclosure, the micro-droplet spray unit (300) may include a sealing cover member (310) screw-coupled to an upper opening of the water storing chamber (110), a pumping unit (320) coupled by being fixed to a center of the sealing cover member (310), a pipe member (321) by being connected to a center of the pumping unit (320) to supply the functional water in the water storing chamber (110) to the pumping unit (320), and a cap member (330) to protect the pumping unit (320).

Meanwhile, according to another exemplary embodiment of the present disclosure, as illustrated in FIG. 6, the micro-droplet spray unit (300) may be replaced by a lid member (400), when the micro-droplet spray unit (300) is not required.

According to an exemplary embodiment of the present disclosure, a user can produce electric power required for operating the apparatus by shaking the apparatus 5 to 10 times, without any inconvenient maintenance such as battery replacement or charging rechargeable batteries. Thus, the apparatus according to an exemplary embodiment of the present disclosure may be used semi-permanently in comparison with conventional products, and may be safer because a low-capacity electric power is used.

According to an exemplary embodiment of the present disclosure, the apparatus may, by changing positions of electrodes through a simple switching operation, manufacture functional water for a cosmetic use by contacting the electrode generating hydrogen to the water, or may manufacture functional water for a sterilizing use by contacting the electrode generating ozone to the water. Therefore, the apparatus according to an exemplary embodiment of the present disclosure can manufacture functional water having two different functionalities in a single device.

Especially, a user can choose and use any desirable raw water such as purified water and distilled water other than tap water, because the water may be electrolyzed irrespective of quality of the raw water. Therefore, the apparatus according to an exemplary embodiment of the present disclosure can enhance the user convenience.

The abovementioned exemplary embodiments are intended to be illustrative, and not to limit the scope of the claims. Many alternatives, modifications, variations, and equivalents will be apparent to those skilled in the art. The features, structures, methods, and other characteristics of the exemplary embodiments described herein may be combined in various ways to obtain additional and/or alternative exemplary embodiments within an equivalent scope. Therefore, the technical scope of the rights for the present disclosure shall be decided by the claims.

The present disclosure may be applied to a technical field relating to manufacturing functional water.

What is claimed is:

1. A functional water manufacturing apparatus with self-generated electric power, the apparatus comprising:
a water storing chamber configured to store one of a tap water, a purified water, a distilled water, and a water containing an adduct;
an electrode unit configured to form a bottom surface by being coupled to a lower part of the water storing chamber, and to expose one of a positive electrode and a negative electrode; and
a power supply unit configured to supply an electric power to the electrode unit by being arranged at a lower part of the electrode unit, and to generate an electric power by converting a kinetic energy added by a user to an electric energy,
wherein the electrode unit converts the water stored in the water storing chamber to a functional water, by being supplied with the electric power from the power supply unit.

2. The apparatus of claim 1, wherein
the electrode unit includes an electrode module having a diameter corresponding to a diameter of the water storing chamber, and
the electrode module includes:
a first frame and a second frame;
a first electrode and a second electrode interposed between the first frame and the second frame, each of the first and second electrodes connected to a power source of different polarity; and
a solid polymer electrolyte membrane interposed between the first electrode and the second electrode.

3. The apparatus of claim 2, wherein the power supply unit includes:
a control module unit conductively connected to the first and second electrodes, by being arranged at a lower part of the electrode unit; and
a power generation unit to convert a kinetic energy of a user to an electric energy, by being conductively connected to the control module unit,
wherein the power generation unit includes:
a core block installed by being fixed inside the power supply unit;
a coil wound on the core block;
a guide rail arranged in a longitudinal direction of the power supply unit, so as to be concentric with the core block; and
a magnet to move along the guide rail.

4. The apparatus of claim 3, wherein
the magnet has, in a center thereof, a through-hole in a shape corresponding to a diameter of the guide rail, and is formed smaller than a diameter of an internal space of the core block.

5. The apparatus of claim 4, wherein the power generation unit includes:
a pair of elastic members to collide with the magnet during reciprocative movement of the magnet, by being installed at both ends of the guide rail.

6. The apparatus of claim 5, wherein
the elastic member contacts by a point contact with the magnet when initially contacting with the magnet, by being provided in a shape of a sphere made of either one of a rubber, a silicon, or an urethane material.

7. The apparatus of claim 5, wherein
the elastic member is formed as either one of a coil spring or a leaf spring, and a shape of the spring is transformable by an impact occurring when colliding with the magnet.

8. The apparatus of claim 3, wherein
a sealing member is interposed between the first and second electrodes and the control module unit, to prevent the water stored in the water storing chamber from being injected into the control module unit.

9. The apparatus of claim 3, wherein
the power supply unit includes, on a bottom surface thereof, an attachable/detachable cover member.

10. The apparatus of claim 1, wherein
the water storing chamber includes, at an upper part thereof, one of a micro-droplet spray unit and a lid member, being attachably and detachably coupled with the water storing chamber.

11. The apparatus of claim 10, wherein the micro-droplet spray unit includes:
a sealing cover member screw-coupled to an upper opening of the water storing chamber;
a pumping unit coupled by being fixed to a center of the sealing cover member;
a pipe member, by being connected to a center of the pumping unit, to supply the functional water in the water storing chamber to the pumping unit; and
a cap member to protect the pumping unit.

12. The apparatus of claim 1, wherein
the power supply unit generates an electric power during reciprocative movement in a longitudinal direction of the functional water manufacturing apparatus.

13. The apparatus of claim 3, wherein
the control module unit further includes a switching unit to ON/OFF-control an electric power applied to the first and second electrodes.

14. The apparatus of claim 13, wherein
the switching unit further includes a function to convert a polarity of the electric power applied to the first and second electrodes.
